(19) United States
(12) Patent Application Publication
(10) Pub. No.: US 2006/0190408 A1
(43) Pub. Date: Aug. 24, 2006

(54) System and method for customized bundled license generation

(76) Inventors: Johanna Madelaine Cook, Charlotte, NC (US); Erich Shannon Magee, Cary, NC (US); Hirenkumar Ishvarbhai Patel, Sanford, NC (US)

Correspondence Address: VAN LEEUWEN & VAN LEEUWEN, P.O. BOX 90609, AUSTIN, TX, 78709-0609, US

(21) Appl. No.: 11/065,236

(22) Filed: Feb. 24, 2005

(51) Int. Cl. G06F 17/60

(52) U.S. Cl. 705/59

(57) ABSTRACT

A system and method for customized bundled license generation is presented. A license generator uses license sections as building blocks in order to dynamically generate a customized bundled license agreement for use with a bundled software package offering. Each license section has attributes, which are used to select the license sections to include in a customized bundled license. The license generator receives installation parameters from an installer, and matches the installation parameters with the section attributes. Once the license generator matches one or more of the section parameters with one or more section attributes, the license generator retrieves corresponding license sections and generates a customized bundled license. In addition, the license generator may receive user information, such as a user name and department number, which the license generator includes in the customized bundled license.

### BACKGROUND OF THE INVENTION

1. Technical Field

The present invention relates in general to a system and method for customized bundled license generation. More particularly, the present invention relates to a system and method for dynamically generating a customized bundled license based upon one or more installation parameters.

b 2. Description of the Related Art

Software companies provide bundled software packages to a wide variety of customers. Some customers may be internal to their own organization, while other customers may be external to their company. These bundled software packages typically include multiple software products, whereby different vendors may provide some of the software products. For example, a company may sell a bundled software package offering that includes a word processing application, a digital photography application, a drawing application, and a web browser application. In this example, the company may develop the word processing and drawing application, but include a different vendor's digital photography and web browser application.

When installing a bundled software package, a user is typically required to review and agree to multiple licensing agreements, each one pertaining to an individual software product. A challenge found with this approach is that the company that provides the bundled software package may wish to have the user agree to a high-level bundled software package license, especially when the company has incorporated different vendor software products into its bundled software package. Furthermore, reviewing license agreements for each software product is time consuming for the user.

In addition, some customers may wish to purchase a subset of software products that are included in a bundled software package. Using the example described above, a customer may only wish to purchase the web browser application and the drawing application that is included in the bundled software package. A challenge found is that a company is typically required to develop multiple bundled software package offerings that include various software products, along with their corresponding license agreements, in order to support various installation scenarios.

What is needed, therefore, is a system and method for dynamically generating a customized license agreement for a bundled software package that is based upon one or more installation parameters.

### SUMMARY

It has been discovered that the aforementioned challenges are resolved by using license sections as building blocks in order to dynamically generate a customized bundled license agreement for use with a bundled software package offering. Each license section has attributes, which are used to select the license sections to include in a customized bundled license. A license generator receives installation parameters from an installer and matches the installation parameters with the section attributes. Once the license generator matches one or more of the section parameters with one or more section attributes, the license generator retrieves corresponding license sections and generates a customized bundled license. In addition, the license generator may receive user information, such as a user name and department number, which the license generator includes in the customized bundled license.

A license generator receives an installation key from an installer. The installation key includes installation parameters that may identify a user role (e.g., developer or production), an installation type (e.g., OEM or standard), particular package offerings, or other installation parameters. The license generator matches the installation parameters with section attributes that are associated with the license sections in order to determine which license sections to include in a customized bundled license.

In one embodiment, when the bundled offering initiates a silent installation for individual software package offerings, the license generator may pass configuration parameters to each of the individual package offerings. The configuration parameters may instruct the package offering to link to the customized bundled license, or enable/disable particular features. In another embodiment, during the silent installation, the bundled offering may allow each individual software package offering to install as usual, and then override each individual package offering's license agreement (e.g., license.txt file) with the customized bundled license.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a license generator generating a customized license for a software package offering whereby the customized license is based upon a user role;

FIG. 2 is a diagram showing a license generator generating a customized bundled license based upon an installation key for use with a bundled package offering;

FIG. 3 is a high-level flowchart showing steps taken in receiving a user role key and generating a customized license based upon the user role key;

FIG. 4 is a flowchart showing steps taken in customizing a license based upon a license template and user information;

FIG. 5 is a flowchart showing steps taken in generating a customized bundled license based upon an installation key;

FIG. 6 is a flowchart showing steps taken in installing identified software package offerings from a bundled package offering, and linking a customized bundled license to each of the installed software package offerings;

FIG. 7A is a diagram of user role license templates;

FIG. 7B is a diagram showing various license sections and their respective attributes;

FIG. 8 is a diagram showing a table that associates section attributes with installation parameters; and

FIG. 9 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

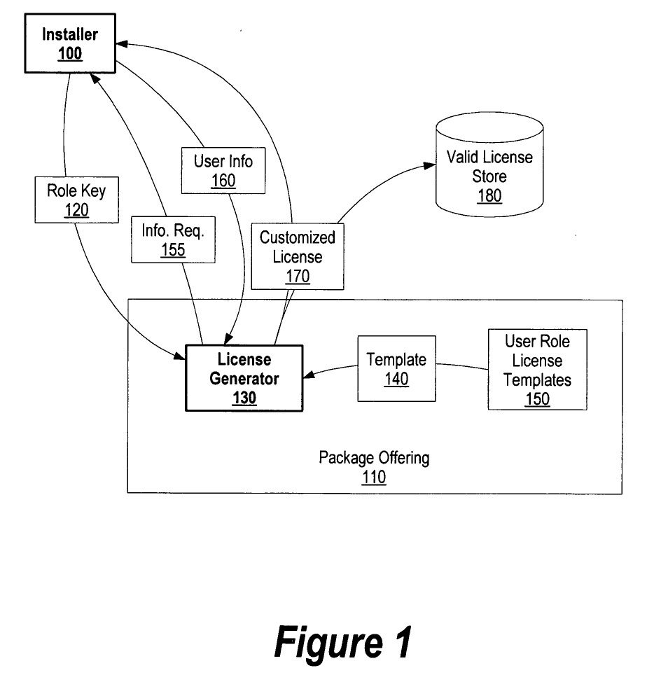

FIG. 1 is a diagram showing a license generator generating a customized license for a software package offering whereby the customized license is based upon a user role. License generator 130 analyzes role keys that it receives from installer 100 and associates a user role to the role key, such as “developer” or “production.” Once license generator 130 identifies a user role, license generator 130 retrieves a corresponding license template (e.g., a developer template) and customizes the license template based upon user information it receives from installer 100.

Installer 100 wishes to load package offering 110 on a computer system. Package offering 110 includes license generator 130, which creates a customized license using a license template that is included in user role license templates 150. User role license templates 150 may include individual templates that correspond to valid user roles, such as a “production template” and a “developer template.”

Installer 100 provides role key 120 to license generator 130, whereby role key 120 corresponds to a particular user role. License generator 130 analyzes role key 120 and identifies a corresponding user role. License generator 130 may identify the corresponding user role using many common approaches. In one embodiment, one group of role keys may correspond to a developer role (e.g. 0000-2222), while another group of role keys may correspond to a production role (e.g. 3333-8888).

Once license generator 130 identifies a user role, license generator 130 retrieves a corresponding template, such as template 140 from user role license templates 150. License generator 130 identifies user information that is required in order to customize template 140, and sends information request 155 to installer 100. For example, information request 155 may include a request for the user's name and department number. Installer 100 responds by sending the user information (e.g., user information 160) to license generator 130.

License generator 130 incorporates user information 160 into template 140, and creates customized license 170, which is stored in valid license store 180. During installation, package offering 110 installs its software application, and uses customized license 170 as a corresponding license agreement. In one embodiment, license generator 130 may link customized license 170 to the installed software, whereas in another embodiment license generator 130 may override the software's standard license with customized license 170. In yet another embodiment, package offering 110 may limit features based upon the identified user role. For example, if the user role is identified as “production,” package offering 110 may inhibit particular developmental features when the software package is installed. Valid license store 180 may be stored on a nonvolatile storage area, such as a computer hard drive.

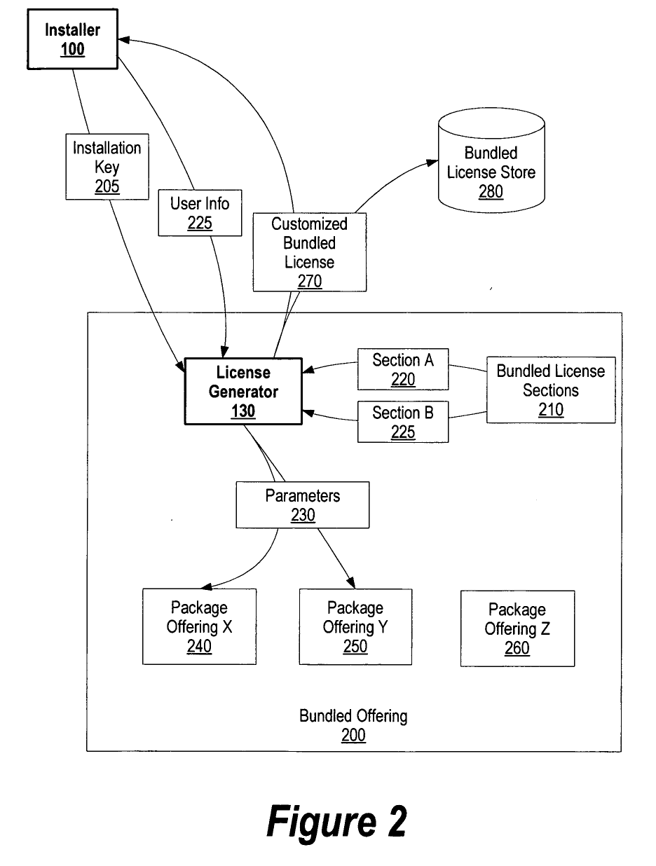

FIG. 2 is a diagram showing a license generator generating a customized bundled license based upon an installation key for use with a bundled package offering. FIG. 2 is different than FIG. 1 in the sense that FIG. 2 shows an example of license generator 130 generating a “bundled” customized license to correspond with a bundled package offering (i.e. bundled offering 200) as opposed to generating a user role license agreement for a single software package offering, which is shown in FIG. 1. A bundled package offering includes multiple individual software package offerings, such as package offering X 240, package offering Y 250, and package offering Z 260, which are bundled together and distributed as a single offering within bundled offering 200.

When a company distributes bundled package offerings, the company may wish to have one bundled customized license agreement for a user to agree instead of individual license agreements for each individual package offering. In addition, when a customer requests to purchase only some of the software packages that are included in a bundled offering, the company may not wish to create a bundled offering that is specialized to the customer's requirements. In these situations, license generator 130 uses installation parameters that it receives from installer 100 in order to determine which license sections to include in a customized bundled license so the company may use a single bundled package offering to support a variety of customer requirements.

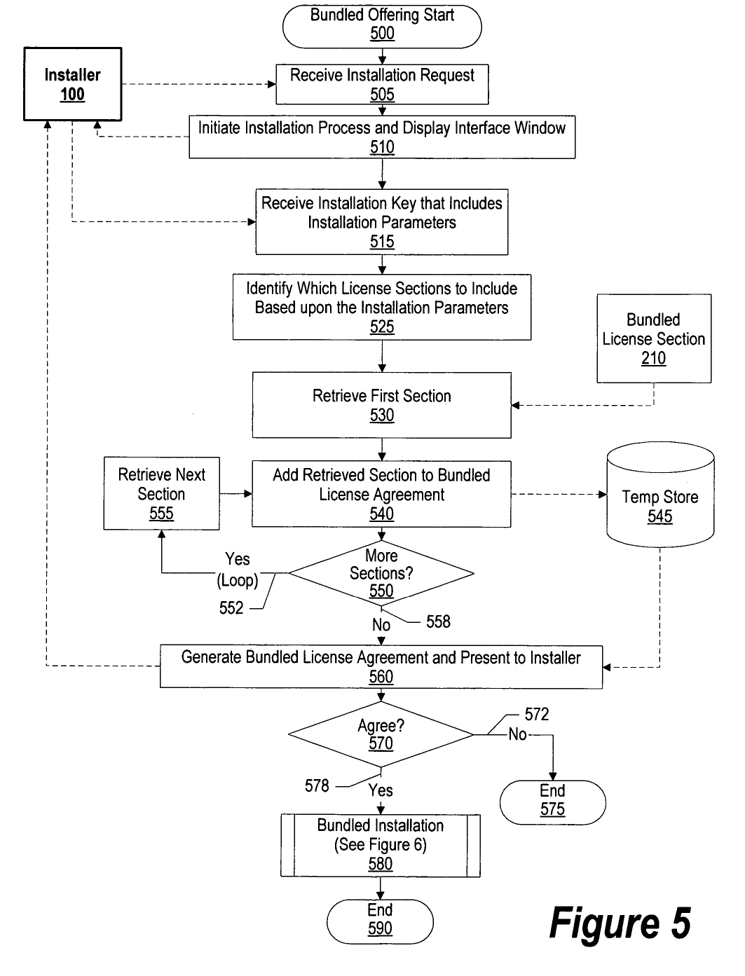

License generator 130 receives installation key 205 from installer 100. Installation key 205 includes installation parameters that may identify a user role (e.g., developer or production), an installation type (e.g., OEM or standard), particular package offerings, or other installation parameters. License generator 130 matches the installation parameters with section attributes that are associated with the license sections in order to determine which license sections to include in a customized bundled license (see FIGS. 5, 7B, 8, and corresponding text for further details regarding license sections and section attributes). Once license generator 130 identifies the section attributes that match one or more installation parameters, license generator retrieves the section attributes' corresponding license sections. The example shown in FIG. 2 shows that license generator 130 retrieves license section A 220 and license section B 225 from bundled license templates 210.

License generator 130 uses license section A 220 and license section B 225 to generate customized bundled license 270 and store customized bundled license 270 in bundled license store 280. Depending upon the type of installation, license generator 130 may receive user information 225 from installer 100, and include user information 225 in customized bundled license 270. For example, user information may be included during a standard installation but may not be included during an OEM installation. Bundled license store 280 may be stored on a nonvolatile storage area, such as a computer hard drive.

In one embodiment, when bundled offering 200 initiates a silent installation for package offering X 240 and package offering Y 250, license generator 130 may pass parameters 230 to each of the individual package offerings. Parameters 230 include a link to customized bundled license 270 as well as configuration parameters. A software package offering may use the configuration parameters to enable or disable particular features. In this embodiment, the individual package offerings are enabled to receive parameters 230. In another embodiment, during the silent installation, bundled offering 200 may allow each individual package offering to install as usual, and then override each individual package offering's license agreement (e.g., license.txt file) with customized bundled license 270 (see FIG. 5 and corresponding text for further details regarding bundled license generation).

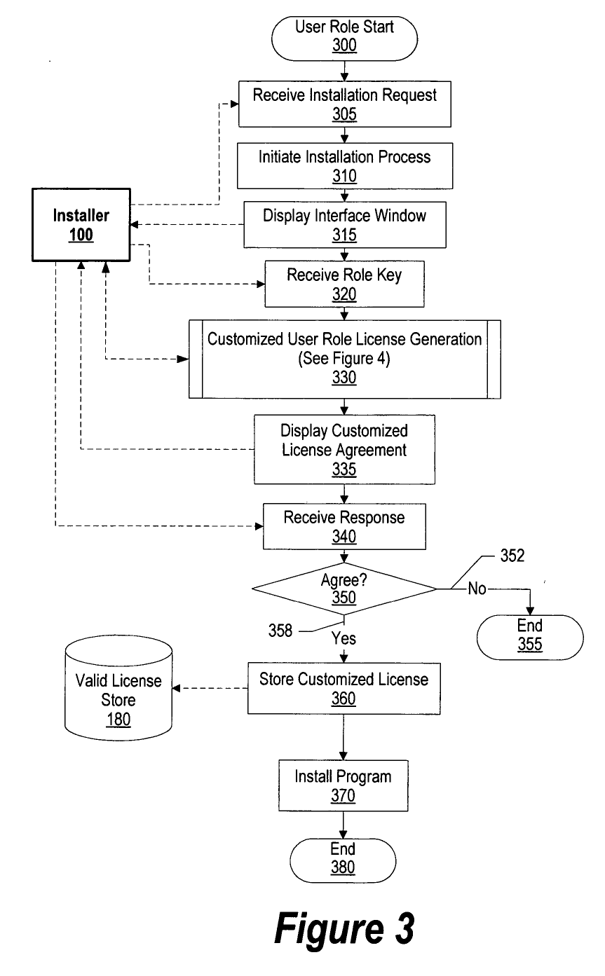

FIG. 3 is a high-level flowchart showing steps taken in receiving a user role key and generating a customized license based upon the user role key. A license generator analyzes the role key and associates a user role to the role key, such as developer, production, etc. Once the license generator identifies a user role, the license generator retrieves a corresponding license template and customizes the license template based upon user information.

User role processing commences at 300, whereupon processing receives an installation request from installer 100 at step 305. Installer 100 is the same as that shown in FIG. 1, and may be a person that manages a company's software installations, such as a system administrator. Processing initiates an installation process at step 310, and displays a user interface window to installer 100 at step 315. The user interface window includes areas for installer 100 to enter a role key. For example, a user may receive a role key from a manufacturer when the user purchases the software, whereby the role key corresponds to the environment that the user plans to execute the software package offering (e.g. developer environment).

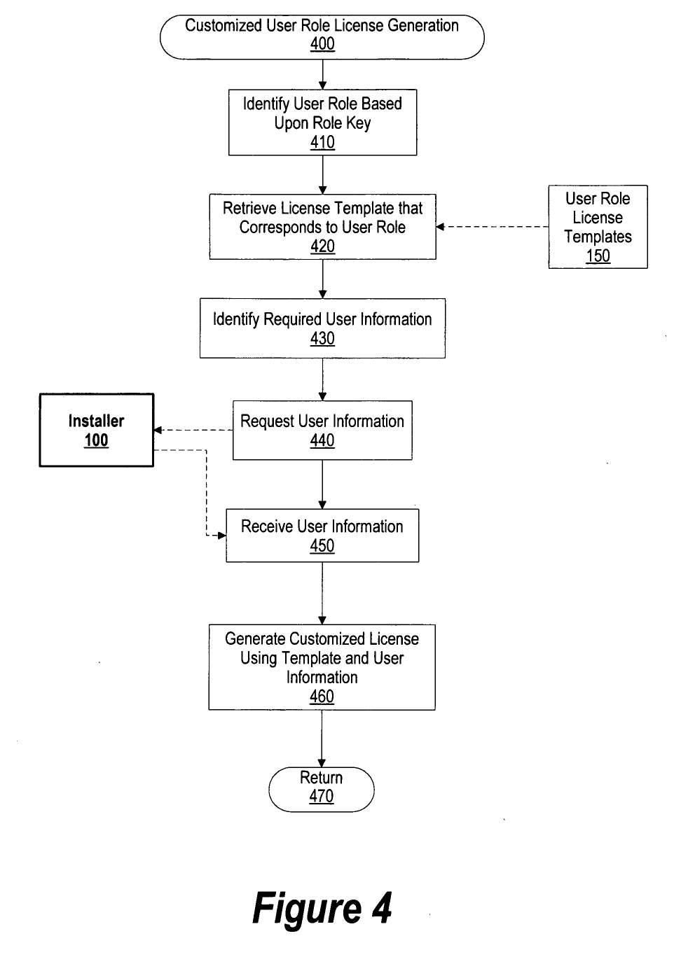

Processing receives the role key at step 320, whereupon processing uses the role key to identify a user role and generate a customized license based upon the user role (pre-defined process block 330, see FIG. 4 and corresponding text for further details). For example, processing may determine that the role key that installer 100 provided corresponds to a “production” user role. In this example, processing uses a “production” template as its basis for generating a customized license.

Processing displays the generated customized license to installer 100 at step 335. Installer 100 reviews the customized license, and provides a response, which processing receives at step 340. A determination is made as to whether installer 100 agreed to the terms and conditions that are included in the customized license (decision 350). If installer 100 does not agree to the terms and conditions that are included in the customized license, decision 350 branches to “No” branch 352 whereupon processing ends at 355 and the software offering is not installed.

On the other hand, if installer 100 does agree to the terms and conditions that are included in the customized software license, decision 350 branches to “Yes” branch 358 whereupon processing stores the customized license in valid license store 180 (step 360). Valid license store 180 is the same as that shown in FIG. 1 and is accessible by a corresponding software offering. For example, if installer 100 is installing a software offering on a remote computer, valid license store 180 may be located on the remote computer such that the software offering has access to the customized license when a user wishes to view the customized license on the remote computer.

Processing installs the software package offering at, step 370. In one embodiment, during the installation process, processing may pass parameters to the software package offering that correspond to the user role. In this embodiment, the software offering may limit particular features of the software program. For example, if the user role is “production,” the software offering may disable development type features of the software program when the software program is installed. Processing ends at 380.

FIG. 4 is a flowchart showing steps taken in customizing a license based upon a license template and user information. A license generator received an installation request from an installer, whereby the installer provided a role key that corresponds to a user. The installer may be the user, or the installer may install the software program for other users. For example, a system administrator may install a software package offering for each user that belongs to a particular department. In this example, some users may be “developers,” while other users may be “production” users.

Processing commences at 400, whereupon processing identifies a user role based upon a role key that the installer provided (step 410). The user role may be identified using many common approaches. In one embodiment, one group of role keys may correspond to a developer role (e.g. 0000-2222), while another group of role keys may correspond to a production role (e.g. 3333-8888).

At step 420, processing retrieves a license template that corresponds to the identified user role from user role license templates 150. For example, if the identified user role is “developer,” then processing retrieves a “developer” template from user role license templates store 150 whereby the developer template includes terms and conditions that are based upon a user executing the corresponding software package offering as a developer. User role license templates 150 is the same as that shown in FIG. 1, and may be stored on a nonvolatile storage area, such as a computer hard drive.

Processing identifies required user information based upon the retrieved license template at step 430. For example, if the template is a “production” template, the template may require user information that corresponds to the user's production environment. At step 440, processing requests user information from installer 100 and, at step 450, processing receives the user information from installer 100. Installer 100 is the same as that shown in FIG. 1.

Using the received user information and the retrieved license template, processing generates a customized license at step 460. The customized license may be particular to a particular user, or the custom license may be particular to a particular group or department. For example, installer 100 may install a software offering for production users whereby the production users are included in a group. In this example, processing generates a customized license whereby a group license is stored on each of the group's user's computer systems (see FIG. 3 and corresponding text for further details regarding customized license storage steps). Processing returns at 470.

FIG. 5 is a flowchart showing steps taken in generating a customized bundled license based upon an installation key. A bundled package offering includes multiple individual package offerings that are bundled together and distributed as a single offering. When companies distribute bundled package offerings, the company may wish to have one bundled customized license agreement for a user to agree instead of individual license agreements for each individual package offering. In addition, a customer may only wish to purchase some of the software packages that are included in a bundled offering. In this situation, the software company that sells the bundled offering may not wish to create a different bundled offering that only includes the software packages that the customer requests. Rather, the software company includes a license generator that creates a customized license based upon the software packages that a customer requests, as well as provides a means to install only the software packages that the customer requests.

Processing commences at 500, whereupon processing receives an installation request from installer 100 at step 505. Installer 100 is the same as that shown in FIG. 1. At step 510, processing initiates the installation process and displays an interface window to installer 100, which includes an area for installer 100 to enter an installation key. Installer 100 enters an installation key, which processing receives at step 515. The installation key includes information that may identify a user role, an installation environment (e.g. OEM), particular package offerings, as well as other parameters.

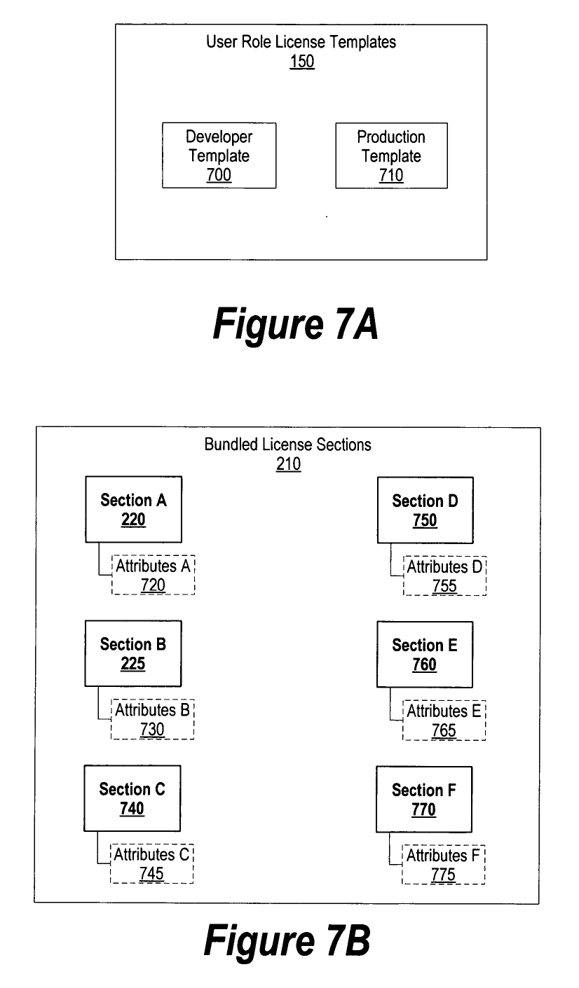

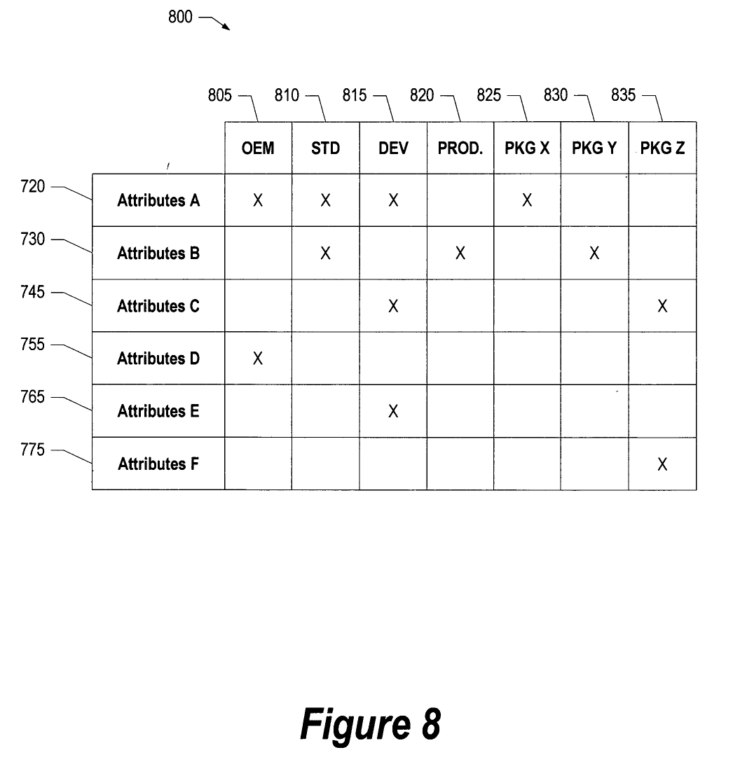

At step 525, processing identifies which license sections to include in a customized license based upon the installation key's installation parameters. For example, the installation key may correspond to installing package “X” in a standard, production environment. In this example, processing identifies licensing sections that correspond to package “X”, a standard installation, or a production environment (see FIGS. 7B, 8, and corresponding text for further details regarding template groups).

Processing retrieves a first section from bundled license sections 210 at step 530. Using the example described above, processing may retrieve “Section A,” which has attributes that correspond to package “x.” Bundled license templates 210 are the same as that shown in FIG. 2. Processing begins creation of a customized bundled license at step 540 by storing the retrieved license section in temporary store 545. Temporary store 545 may be stored on a nonvolatile storage area, such as a computer hard drive, or may be stored on a volatile storage area, such as computer memory.

A determination is made, based upon the installation key, as to whether there are more sections to include in the customized license agreement (decision 550). If there are more software sections to include, decision 550 branches to “Yes” branch 552, which loops back to retrieve (step 555) and add the next license section to the customized bundled license. This looping continues until there are no more license sections to add to the customized bundled license, at which point decision 550 branches to “No” branch 558.

Processing generates a bundled license agreement using the license sections that are located in temporary store 545, and presents the customized bundled license agreement to installer 100 at step 560. In one embodiment, processing receives user information, such as a user name and department number, and includes the user information in the customized bundled license.

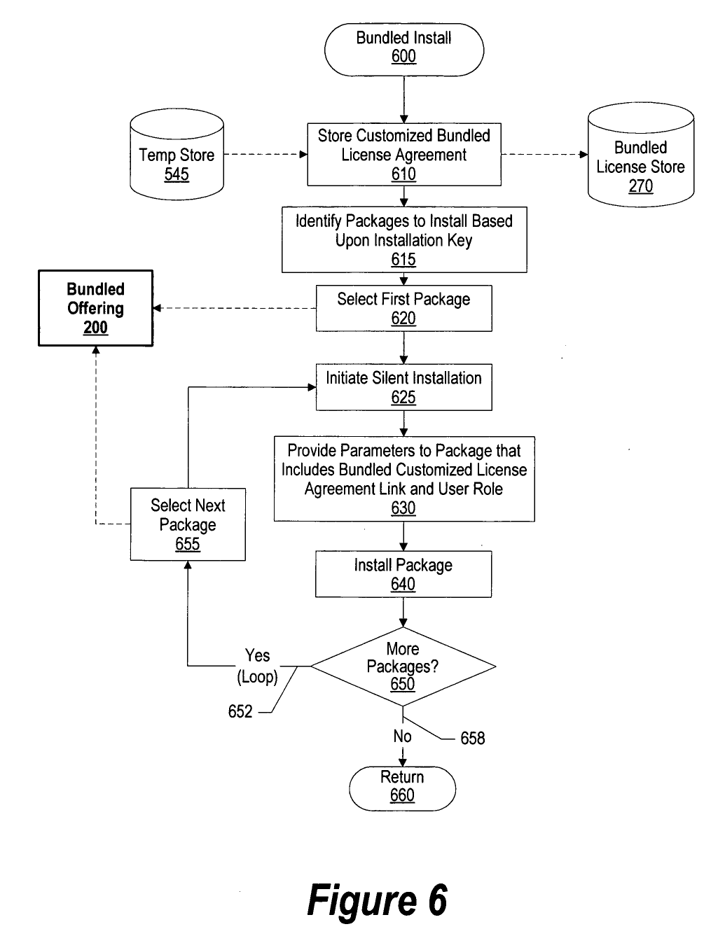

A determination is made as to whether installer 100 agrees to the terms and conditions that are presented in the customized license agreement (decision 570). If the user does not agree to the terms and conditions, decision 570 branches to “No” branch 572 whereupon processing does not install the software offerings and processing ends at 575. On the other hand, if installer 100 agrees to the terms and conditions, decision 570 branches to “Yes” branch 578 whereupon processing installs the software offerings that correspond to the installation key (pre-defined process block 580, see FIG. 6 and corresponding text for further details). Processing ends at 590.

FIG. 6 is a flowchart showing steps taken in installing identified software package offerings from a bundled package offering, and linking a customized bundled license to each of the installed software package offerings. A bundled package offering includes multiple software package offerings, which are bundled together and distributed (see FIG. 2 and corresponding text for further details regarding bundled package offerings). When companies distribute bundled package offerings, the company may wish to have one bundled customized license agreement for a user to review instead of individual license agreements for each individual package offering.

Bundled package offering installation commences at 600, whereupon processing retrieves a generated customized bundled license from temporary store 545 and stores the customized bundled license in bundled license store 270 (step 610). The customized bundled license was generated using license templates that correspond to software package offerings to be installed (see FIG. 5 and corresponding text for further details regarding customized bundled license generation). Temporary store 545 and bundled license store 270 are the same as that shown in FIGS. 5 and 2, respectively.

At step 615, processing identifies packages to install based upon an installation key that was received from an installer (see FIG. 5). The installation key includes information that informs processing as to which software packages to install. For example, bundled offering 200 is the same as that shown in FIG. 2 and includes three package offerings. In this example, the installation key may instruct processing to install only one of the three software package offerings that are included in bundled offering 200.

Processing selects a first package to install from bundled offering 200 based upon the installation key (step 620). At step 625, processing initiates a silent installation for the selected package. A silent installation installs the selected package without human intervention so that an installer is freed from the task of monitoring the installation and providing input to dialog boxes.

In one embodiment during the silent installation, processing provides parameters to the selected package (step 630), whereby the parameters include a link to the generated bundled customized license, as well as user role parameters. In this embodiment, the software package is enabled to receive the parameters. In another embodiment, processing may allow the selected package to install as usual, and then override the selected packages license agreement (e.g., license.txt file) with the bundled customized license.

At step 640, processing installs the selected package. A determination is made as to whether there are more individual package offerings to install in bundled offering 200 (decision 650). If there are more individual package offerings to install, decision 650 branches to “Yes” branch 652, which loops back to select (step 655) and process the next software package. This looping continues until there are no more software packages to install, at which point decision 650 branches to “No” branch 658 whereupon processing returns at 660.

FIG. 7A is a diagram showing license templates that are based upon a user role. User role license templates 150 include two license templates, which are developer template 700 and production template 710. Each of the templates includes licensing terms and conditions that are particular to a user role. When a license generator receives a user role, the license generator retrieves a corresponding template from user role license templates 150, and customizes the template accordingly, such as including a user name and department number. User role license templates 150 are the same as that shown in FIG. 1.

FIG. 7B is a diagram showing various license sections and their respective attributes. A license section is a section of text, such as a paragraph, that corresponds to one or more installation parameters, such as an installation type, a user role, or a package offering identifier. Each license section has associated section attributes, whereby a license generator compares installation parameters it receives from an installer with the section attributes in order to determine which license sections to include in a customized bundled license agreement (see FIG. 8 and corresponding text for further details regarding license section attributes).

Bundled license sections 210 include section A 220, section B 225, section C 740, section D 750, section E 760, and section F 770, and also includes their respective section attributes, which are attributes A 720, attributes B 730, attributes C 745, attributes D 755, attributes E 765, and attributes F 775. Section A 220 and section B 225 are the same as that shown in FIG. 2.

Each license section may include terms and conditions that are relative to a particular topic. For example, section D 750 may include terms and conditions relative to a software package being used in a “developer” user role and, therefore, a license generator includes section D 750 in a customized bundled license each time that an installer provides a “developer” installation parameter.

FIG. 8 is a diagram showing a table that associates section attributes with installation parameters. Table 800 includes six section attributes, which are attributes A 720, attributes B 730, attributes C 745, attributes D 755, attributes E 765, and attributes F 775. Each of the attributes are the same as those shown in FIG. 7B, and are associated with a particular license section (also shown in FIG. 7B).

Table 800 includes seven columns, which are dependent upon the requirements of a particular application. The example shown in FIG. 8 shows that the columns correspond to an installation type, a user role, or a package offering type. Column 805 corresponds to an OEM installation type. When a license generator receives installation parameters from an installer that include an OEM installation type, the license generator identifies that attributes A and attributes D correspond to an OEM installation type and thus, the license generator retrieves license sections A and D to include in a customized bundled license.

Column 810 corresponds to a standard installation type. When a license generator receives installation parameters from an installer that include an standard installation type, the license generator identifies that attributes A and attributes B correspond to an OEM installation type and thus, the license generator retrieves license sections A and B to include in a customized bundled license.

Column 815 corresponds to a developer user role. When a license generator receives installation parameters from an installer that include a developer user role, the license generator identifies that attributes A, C and E correspond to a developer user role and thus, the license generator retrieves license sections A, C, and E to include in a customized bundled license.

Column 820 corresponds to a production user role. When a license generator receives installation parameters from an installer that include a production user role, the license generator identifies that B corresponds to a production user role and thus, the license generator retrieves license B to include in a customized bundled license.

Column 825 corresponds to a software package “X.” When a license generator receives installation parameters from an installer that correspond to software package X identifier, the license generator identifies that attribute A corresponds to software package X and thus, the license generator retrieves license section A to include in a customized bundled license.

Column 830 corresponds to a software package “Y.” When a license generator receives installation parameters from an installer that correspond to software package Y, the license generator identifies that attribute B corresponds to software package Y and thus, the license generator retrieves license section B to include in a customized bundled license.

Column 835 corresponds to a software package “Z.” When a license generator receives installation parameters from an installer that correspond to software package Z, the license generator identifies that attributes C and F correspond to software package Z and thus, the license generator retrieves license sections C and F to include in a customized bundled license.

The license generator may also receive multiple installation parameters, whereby the license generator identifies which attributes correspond to one or more of the installation parameters. For example, when a license generator receives installation parameters that include an OEM installation type, a production user role, and package Z, Table 800 shows that attributes A, B, C, D, and F correspond to one or more of the installation parameters and thus, the license generator retrieves license sections A, B, C, D, and F to include in a customized license.

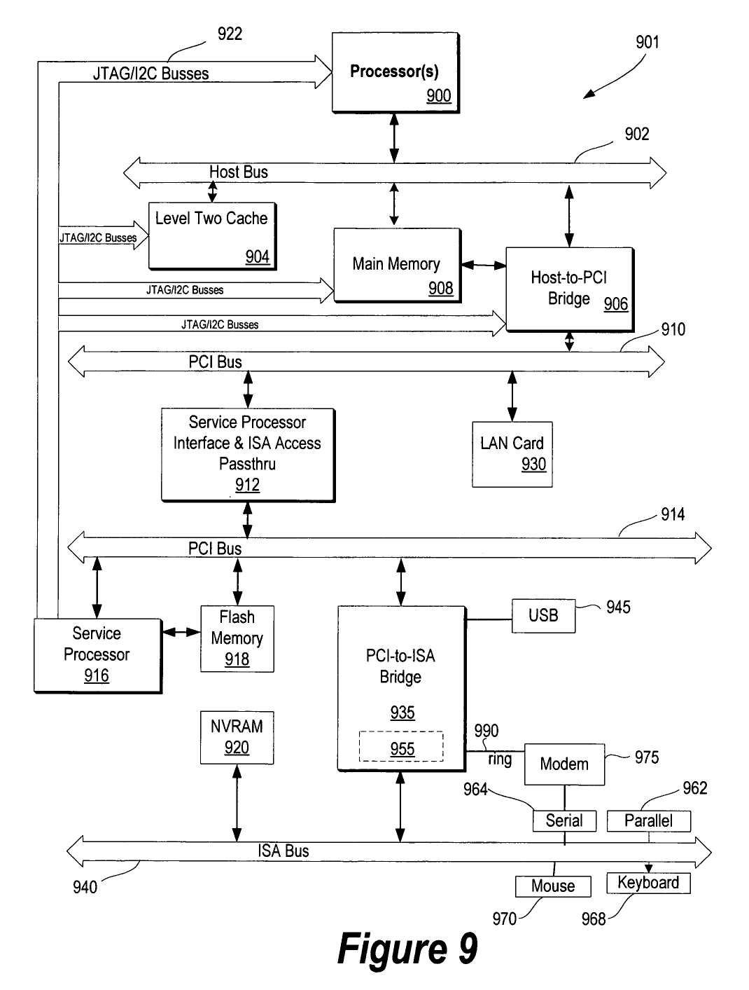

FIG. 9 illustrates information handling system 901, which is a simplified example of a computer system capable of performing the computing operations described herein. Computer system 901 includes processor 900, which is coupled to host bus 902. A level two (L2) cache memory 904 is also coupled to host bus 902. Host-to-PCI bridge 906 is coupled to main memory 908, includes cache memory and main memory control functions, and provides bus control to handle transfers among PCI bus 910, processor 900, L2 cache 904, main memory 908, and host bus 902. Main memory 908 is coupled to Host-to-PCI bridge 906 as well as host bus 902. Devices used solely by host processor(s) 900, such as LAN card 930, are coupled to PCI bus 910. Service Processor Interface and ISA Access Pass-through 912 provides an interface between PCI bus 910 and PCI bus 914. In this manner, PCI bus 914 is insulated from PCI bus 910. Devices, such as flash memory 918, are coupled to PCI bus 914. In one implementation, flash memory 918 includes BIOS code that incorporates the necessary processor executable code for a variety of low-level system functions and system boot functions.

PCI bus 914 provides an interface for a variety of devices that are shared by host processor(s) 900 and Service Processor 916 including, for example, flash memory 918. PCI-to-ISA bridge 935 provides bus control to handle transfers between PCI bus 914 and ISA bus 940, universal serial bus (USB) functionality 945, power management functionality 955, and can include other functional elements not shown, such as a real-time clock (RTC), DMA control, interrupt support, and system management bus support. Nonvolatile RAM 920 is attached to ISA Bus 940. Service Processor 916 includes JTAG and I2C busses 922 for communication with processor(s) 900 during initialization steps. JTAG/I2C busses 922 are also coupled to L2 cache 904, Host-to-PCI bridge 906, and main memory 908 providing a communications path between the processor, the Service Processor, the L2 cache, the Host-to-PCI bridge, and the main memory. Service Processor 916 also has access to system power resources for powering down information handling device 901.

Peripheral devices and input/output (I/O) devices can be attached to various interfaces (e.g., parallel interface 962, serial interface 964, keyboard interface 968, and mouse interface 970 coupled to ISA bus 940. Alternatively, many I/O devices can be accommodated by a super I/O controller (not shown) attached to ISA bus 940.

In order to attach computer system 901 to another computer system to copy files over a network, LAN card 930 is coupled to PCI bus 910. Similarly, to connect computer system 901 to an ISP to connect to the Internet using a telephone line connection, modem 975 is connected to serial port 964 and PCI-to-ISA Bridge 935.

While the computer system described in FIG. 9 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer-implemented method comprising:
receiving one or more installation parameters that correspond to a software installation that includes a plurality of software package offerings;
matching the installation parameters with one or more section attributes;
retrieving a plurality of license sections that correspond to the matched section attributes;
generating a customized license by combining the retrieved plurality of license sections; and
providing a pointer to one or more of the plurality of software package offerings, the pointer used to locate the generated customized license from one of the plurality of software package offerings.

2. (canceled)

3. The method of claim 1 further comprising:
identifying one or more of the plurality of software package offerings to install based upon the installation parameters; and
installing the identified software package offerings.

4. The method of claim 3 further comprising:
providing one or more configuration parameters to one or more of the identified software package offerings, wherein the identified software package offerings are adapted to enable one or more features based upon the configuration parameters.

5. (canceled)

6. The method of claim 1 wherein at least one of the installation parameters are selected from the group consisting of an installation type, a user role, and a software package identifier.

7. The method of claim 1 wherein the package offering and the customized license generation are encapsulated and located on a single computer system.

8. A program product comprising:
computer operable medium having computer readable code, the computer readable code being effective to:
receive one or more installation parameters that correspond to a software installation that includes a plurality of software package offerings;
match the installation parameters with one or more section attributes;
retrieve a plurality of license sections that correspond to the matched section attributes;
generate a customized license by combining the retrieved plurality of license sections; and
provide a pointer to one or more of the plurality of software package offerings, the pointer used to locate the generated customized license from one of the plurality of software package offerings.

9. (canceled)

10. The program product of claim 8 wherein the computer readable code is further effective to:
identify one or more of the plurality of software package offerings to install based upon the installation parameters; and
install the identified software package offerings.

11. The program product of claim 10 wherein the computer readable code is further effective to:
provide one or more configuration parameters to one or more of the identified software package offerings, wherein the identified software package offerings are adapted to enable one or more features based upon the configuration parameters.

12. (canceled)

13. The program product of claim 8 wherein at least one of the installation parameters are selected from the group consisting of an installation type, a user role, and a software package identifier.

14. The program product of claim 8 wherein the package offering and the customized license generation are encapsulated and located on a single computer system.

15. An information handling system comprising:
one or more processors;
a memory accessible by the processors;
one or more nonvolatile storage devices accessible by the processors; and
a license generation tool which generates customized licenses, the license generation tool being effective to:
receive one or more installation parameters from an installer that correspond to a software installation that includes a plurality of software package offerings;
match the installation parameters with one or more section attributes that are located in one of the nonvolatile storage devices;
retrieve a plurality of license sections from one of the nonvolatile storage devices that correspond to the matched section attributes;
generate a customized license by combining the retrieved plurality of license sections; and
provide a pointer to one or more of the plurality of software package offerings, the pointer used to locate the generated customized license located in one of the non-volatile storage devices from one of the plurality of software package offerings.

16. (canceled)

17. The information handling system of claim 15 wherein the license generation tool is further effective to:
identify one or more of the plurality of software package offerings to install based upon the installation parameters; and
install the identified software package offerings on one of the nonvolatile storage devices.

18. The information handling system of claim 17 wherein the license generation tool is further effective to:
provide one or more configuration parameters to one or more of the identified software package offerings over a local computer network, wherein the identified software package offerings are adapted to enable one or more features based upon the configuration parameters.

19. (canceled)

20. The information handling system of claim 15 wherein the package offering and the customized license generation are encapsulated and located on a single computer system.
